(19) United States
(12) Patent Application Publication
(10) Pub. No.: US 2008/0021157 A1
(43) Pub. Date: Jan. 24, 2008

(54) POLYSTYRENE HAVING IMPROVED COLOR AND METHODS OF MAKING SAME

(76) Inventors: Jose M. Sosa, Deer Park, TX (US); Billy Ellis, Spring, TX (US); Steven D. Gray, Bellaire, TX (US)

Correspondence Address: FINA TECHNOLOGY INC, PO BOX 674412, HOUSTON, TX, 77267-4412, US

(21) Appl. No.: 11/456,297

(22) Filed: Jul. 10, 2006

(51) Int. Cl. C08L 9/00; C08L 25/04; B32B 27/00

(52) U.S. Cl. 525/70

(57) ABSTRACT

A method of improving the color of a high impact polystyrene comprising preparing a reaction mixture comprising styrene, elastomer and at least one antioxidant, and introducing to the reaction mixture a color improving additive prior to the addition of any oxidizing agents to the reaction mixture. A high impact polystyrene comprising a color improving additive, an elastomer and at least one antioxidant wherein the color improving additive is present in the reaction process for production of the high impact polystyrene prior to the introduction of an oxidizing agent and wherein the high impact polystyrene has a 50% to 200% reduction in the Yellowness index as determined in accordance with ASTM E 313 when compared to an otherwise identical polystyrene lacking a color improving additive.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Technical Field

The present disclosure relates generally to styrenic polymer compositions and more specifically to polystyrene having improved color and methods of making same.

2. Background

Elastomer-reinforced polymers of monovinylidene aromatic compounds such as styrene, alpha-methylstyrene and ring-substituted styrene have found widespread commercial use. For example, elastomer-reinforced styrene polymers having discrete elastomer particles and/or cross-linked elastomer dispersed throughout the styrene polymer matrix can be useful for a range of applications including food packaging, office supplies, point-of-purchase signs and displays, housewares and consumer goods, building insulation and cosmetics packaging. Such elastomer-reinforced polymers are commonly referred to as impact modified or high impact polystyrene (HIPS) while a styrene homopolymer may be referred to as general-purpose polystyrene (GPPS).

During the production of HIPS or GPPS processing additives may be included to improve the properties of the polymer. These additives may range from mold release agents to dyes or fillers. In addition to their intended function, some additives may react with environmental reagents such as air or other components used during the HIPS/GPPS production process to produce undesirable results. For example, antioxidants such as catechols or phenols which are added to the HIPS production process primarily to stabilize styrene monomer or are present in polybutadiene elastomers, may be oxidized to quinone-type compounds (or simply color bodies) resulting in a discoloration or yellowing of the polymer composition. Collectively these compounds which may react to produce chromophores are referred to herein as color-forming compounds (CFC). In particular, the color of HIPS may be adversely affected by CFCs formed by the decomposition of materials present in the elastomer. For example, during the production of butadiene antioxidants are often included as stabilizers. In some cases; the antoxidants employed are less amenable to the process than those typically employed in HIPS production thereby compounding the amount of such compounds present in the HIPS production process and the discoloration of the polymer. Thus, a need exists for styrenic polymer compositions such as HIPS having an improved color and methods of making same.

### BRIEF SUMMARY OF THE DISCLOSURE

Disclosed herein is a method of improving the color of a high impact polystyrene comprising preparing a reaction mixture comprising styrene, elastomer and at least one antioxidant, and introducing to the reaction mixture a color improving additive prior to the addition of any oxidizing agents to the reaction mixture.

Also disclosed herein is a high impact polystyrene comprising a color improving additive, an elastomer and at least one antioxidant wherein the color improving additive is present in the reaction process for production of the high impact polystyrene prior to the introduction of an oxidizing agent and wherein the high impact polystyrene has a 50% to 200% reduction in the Yellowness index as determined in accordance with ASTM E 313 when compared to an otherwise identical polystyrene lacking a color improving additive.

The foregoing has outlined rather broadly the features and technical advantages of the present disclosure in order that the detailed description of the embodiments that follows may be better understood. Additional features and advantages of the embodiments will be described hereinafter that form the subject of the claims. It should be appreciated by those skilled in the art that the conception and the specific embodiments disclosed may be readily utilized as a basis for modifying or designing of other structures for carrying out the same purposes of the present disclosure. It should also be realized by those skilled in the art that such equivalent constructions do not depart from the spirit and scope of the embodiments as set forth in the appended claims.

### BRIEF DESCRIPTION OF THE DRAWINGS

FIG. 1 is a graph of the yellowness index as a function of calcium stearoyl lactate concentration for the resins in Example 2.

FIG. 2 is a graph of the b values as a function of calcium stearoyl lactate concentration for the resins in Example 2.

### DETAILED DESCRIPTION

In an embodiment, a styrenic polymer composition comprises a polymer of styrene and a color improving additive (CIA). Alternatively, a styrenic polymer composition comprises a polymer of styrene, an elastomer and a CIA. Alternatively, a styrenic polymer composition comprises a polymer of styrene, an elastomer having at least one antioxidant, and a CIA. In an embodiment, a process for the production of a styrenic polymer composition comprises contacting a reaction mixture comprising styrene, an elastomer having at least one antioxidant, and a CIA prior to contacting the reaction mixture with an oxidizing agent. The resultant styrenic polymer composition may be a polystyrene homopolymer such as general-purpose polystyrene (GPPS) or a polystyrene copolymer such as high impact polystyrene (HIPS) having an improved color when compared to an otherwise identical polystyrene lacking a CIA.

In an embodiment, the styrenic polymer composition comprises a polymer of styrene and optionally one or more comonomers. The styrenic polymer composition may be a styrenic homopolymer such as a GPPS. Alternatively, the styrenic polymer composition may comprise a polymer of styrene and an elastomer such as a HIPS. Styrene, also known as vinyl benzene, ethyenylbenzene and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene, disubstituted styrenes such as p-t-butyl styrene as well as unsubstituted styrenes.

In some embodiments, the styrenic polymer composition may comprise an elastomer, and the resultant polymeric composition may be a HIPS. Such HIPS contain an elastomeric phase that is embedded in the polystyrene matrix resulting in the composition having an increased impact resistance. In an embodiment, the styrenic polymer composition is HIPS comprising a conjugated diene monomer as the elastomer. Without limitation, examples of suitable aliphatic conjugated diene monomers include C₄ to C₉ dienes such as butadiene monomers. Examples of suitable conjugated diene monomers include without limitation 1,3-butadiene, 2-methyl-1,3-butadiene, 2 chloro-1,3 butadiene, 2-methyl-1,3-butadiene, and 2 chloro-1,3-butadiene. Blends or copolymers of the diene monomers may also be used. Many commercial formulations of such elastomers may include at least one antioxidant as a stabilizer.

In an embodiment, the styrenic polymer composition contains at least one antioxidant. The antioxidants may be included in the reaction mixture as an additive or may be present in the commercial formulations of other reagents for use in the production of the styrene polymer composition. In an embodiment, the antioxidant is present with an elastomer. In an embodiment, the antioxidant is a phenol, a catechol, or combination thereof. Such antioxidants may react with metals present in the polymeric reaction mixture such as iron or zinc to produce color-forming compounds (CFCs). Examples of antioxidants include without limitation tris-nonylphenylphosphite (TNPP); 2,6 ditertiarybutyl-4-methyl phenol (BHT); octadecyl 3,5-Di-(tert)-butyl-4-hydroxyhydrocinnamate (commercially available as IRGANOX 1076 from Ciba); 4-bis[(octylthio)methyl]-o-cresol (commercially available as IRGANOX 1520 from Ciba); or combinations thereof. In an embodiment, a styrenic polymer composition may contain an antioxidant in amounts of from 100 ppm to 10,000 ppm, alternatively from 500 ppm to 7,000 ppm, alternatively from 500 ppm to 4000 ppm, alternatively from 500 ppm to 1500 ppm, alternatively from 750 ppm to 1500 ppm, alternatively from 750 ppm to 1300 ppm, alternatively from 750 ppm to 1000 ppm.

In an embodiment, the styrenic polymer composition may comprise compounds such as metallic stearates and initiators. In an embodiment, the styrenic polymer composition may comprise a metallic stearate such as zinc stearate. Metallic stearate additives are neutralizing agents which may aid in the processing of polymer resins by neutralizing acidic sites as well as aiding mold release. In an embodiment, a styrenic polymer composition may contain a neutralizing agent such as a metallic stearate in amounts of from 50 ppm to 2500 ppm, alternatively from 200 ppm to 1400 ppm, alternatively from 500 ppm to 1200 ppm, alternatively from 50 ppm to 1000 ppm, with all ppm values stated herein by weight unless otherwise indicated.

In an embodiment, the styrenic polymer composition comprises an initiator or the byproducts of an initiator reaction. Initiators, sometimes referred to as accelerators, are compounds that function as the source of free radicals to enable the polymerization of styrene. In an embodiment, any initiator capable of free radical formation that facilitates the polymerization of styrene may be employed. Such initiators are well known in the art and include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. The selection of initiator and effective amount will depend on numerous factors (e.g. temperature, reaction time) and can be chosen by one skilled in the art to meet the desired needs of the process. For example, the initiator may be present in an amount of from 0.001% to 2%, alternatively from 0.01% to 2%, alternatively from 0.1% to 1%.

In an embodiment, the styrenic polymer composition comprises a CIA. The CIA may function to inhibit the oxidation of other components of the polymer composition such as for example and without limitation the antioxidants. Said CIA may be the salt of an organic acid, alternatively an alkali salt of an organic acid, alternatively an alkali salt of lactic acid, alternatively sodium stearoyl lactate, alternatively calcium stearoyl lactate (CSL) or combinations thereof. In an embodiment, the CIA may be present in amounts of from 100 ppm to 5000 ppm, alternatively from 250 ppm to 4000 ppm, alternatively from 500 ppm to 2500 ppm, alternatively from 800 ppm to 2000 ppm. CSL, which is widely commercially available, may be obtained by combining lactic acid and stearic acid, and then reacting the product with calcium hydroxide to make the calcium salt. Over-based forms such as those that limit the level of acid may also be employed. In an embodiment, the CIA may be calcium stearoyl lactate. In such embodiments, the calcium stearoyl lactate may be present in an amount of from 100 ppm to 5000 ppm, alternatively from 250 ppm to 4000 ppm, alternatively from 500 ppm to 2500 ppm, alternatively from 800 ppm to 2000 ppm.

In an embodiment, the styrenic polymer composition may also contain additives to impart desired physical properties, such as, increased gloss or color. Examples of additives include without limitation chain transfer agents, talc, antioxidants, UV stabilizers, lubricants, mineral oil, plasticizers and others as known to one of ordinary skill in the art.

The aforementioned additives may be used either singularly or in combination to form various formulations of the styrenic polymer composition. For example, stabilizers or stabilization agents may be employed to help protect the styrenic polymer composition from degradation due to exposure to excessive temperatures and/or ultraviolet light. These additives may be included in amounts effective to impart the desired properties. Effective additive amounts and processes for inclusion of these additives to styrenic polymeric compositions are known to one skilled in the art.

Any process known to one of ordinary skill in the art for the production of a styrenic polymer composition may be employed. In an embodiment the reaction process begins with a reaction mixture comprising styrene, a CIA, an elastomer having at least one antioxidant, and optionally additional components such as those described herein or as known to one of ordinary skill in the art. Said reaction mixture may be introduced to a polymerization reactor system, which will be described in detail later herein to allow for the formation of a styrenic polymer composition.

In an embodiment, the polymerization of styrene is carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an embodiment, the polymerization reaction may be carried out using a continuous production process in a polymerization apparatus comprising a single reactor or a plurality of reactors. For example, the styrenic polymer composition can be prepared using an upflow reactor. Reactors and conditions for the production of a styrenic polymer composition are disclosed in U.S. Pat. No. 4,777,210, which is incorporated by reference herein in its entirety.

The temperature ranges useful with the process of the present disclosure can be selected to be consistent with the operational characteristics of the equipment used to perform the polymerization. In one embodiment, the temperature range for the polymerization can be from 90° C. to 240° C. In another embodiment, the temperature range for the polymerization can be from 100° C. to 180° C. In yet another embodiment, the polymerization reaction may be carried out in a plurality of reactors with each reactor having an optimum temperature range. For example, the polymerization reaction may be carried out in a reactor system employing a first and second polymerization reactors that are either continuously stirred tank reactors (CSTR) or plug-flow reactors. The first polymerization reactor may be referred to herein as the prepolymerization reactor. In an embodiment, a polymerization reactor for the production of an impact-modified styrene comprising a plurality of reactors may have the first reactor (e.g. a CSTR), also known as the prepolymerization reactor, operated in the temperature range of from 90° C. to 135° C. while the second reactor (e.g. CSTR or plug flow) may be operated in the range of from 100° C. to 165° C.

The polymerized product effluent from the first reactor may be referred to herein as the prepolymer. In an embodiment, the residence time or the amount of time the reaction mixture is held within the reactor system may range from 0.5 to 14 hours, alternatively 1 to 8 hours, alternatively 2 to 5 hours. In another embodiment, the residence time is the time required for approximately 20-40% conversion of the monomer(s) to prepolymer. When the prepolymer reaches the desired conversion, it may be passed through a heating device into a second reactor for further polymerization. The polymerized product effluent from the second reactor may be further processed as is known to one of ordinary skill in the art and described in detail in the literature. Processes and equipment for the production of a HIPS are disclosed in U.S. patent application Ser. No. 11/384,737 entitled “Reactor System for the Production of High Impact Polystyrene” and U.S. patent application Ser. No. 11/384,596 entitled “Horizontal Boiling Plug Flow Reactor,” both filed Mar. 20, 2006, and incorporated by reference herein in their entirety.

In an embodiment, the CIA is present in the reaction mixture prior to the addition of any compound that may serve as an oxidizing agent. Without limitation examples of oxidizing agents which are commonly found in the reaction processes for the production of styrenic polymer compositions include metallic stearates, initiators, air, or combinations thereof. The CIA may be included in the reaction mixture which enters the prepolymerization reactor. The polymeric composition emerging from the prepolymerization reactor may then enter a second reactor such as described previously or other reactor located downstream of the prepolymerization reactor where oxidizing agents such as a metallic stearate may be introduced. The presence of the CIA (e.g., CSL) may prevent or inhibit the metallic stearate from reacting with other components of the reaction mixture thus preventing the production of CFCs.

Alternatively, the reaction mixture comprises styrene and an oxidizing agent. In such embodiments, the CIA may be introduced to the composition prior to the addition of an antioxidant to inhibit or prevent CFC formation. In either embodiment, the antioxidant may be included directly as an additive in the reaction mixture or may be introduced indirectly as a component in another reagent, for example the antioxidant may be a component in the elastomer formulation.

Without wishing to be limited by theory, the interaction of an antioxidant such as Irganox-1520 with zinc stearate may lead to the formation of a colored adduct (1520, Zn adduct) through the reaction postulated in Equation 1. This type of interaction is believed to accelerate the oxidation of the antioxidant species to a highly-colored quinone-type structure.

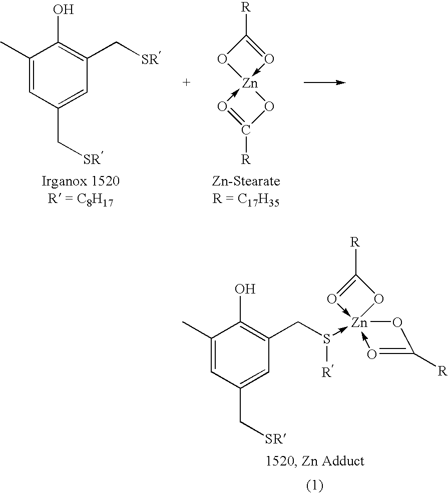

In Equation 1, the metallic stearate, in this case zinc stearate (ZnSt) is believed to lower the activation barrier by which the antioxidant (IRGANOX 1520) reacts to produce a chromophore as an undesirable color adduct.

The color formation in the polymer composition may be assessed using any technique known to one of ordinary skill in the art for the assessment of color in a polymeric composition. For example and without limitation, the color of the polymer composition may be assessed using a colorimeter. Without intending to be limited by theory, the addition of the CIA as described herein may prevent the formation of the undesirable color adduct via inhibiting the reaction as shown in Equation 1.

In an embodiment, a reaction mixture for the production of a styrenic homopolymer may comprise from 75% to 99% styrene, from 0.001% to 0.2% initiator, from 0.05% to 1.0% CIA (e.g. CSL) and optionally additional components as needed to impart the desired physical properties. The percent values given are percentages by weight of the total composition. Alternatively, for the production of a high impact styrenic copolymer the reaction mixture may comprise from 75% to 99% styrene, from 1% to 15% elastomer, from 0.001% to 0.2% initiator, from 0.005% to 0.5% CIA (e.g., CSL) and optionally additional components as needed to impart the desired physical properties.

The reaction mixtures may be subjected to solution or mass polymerization processes such that the residence time of the mixture components may range from 0.5 to 14 hours, alternatively from 1 to 8 hours alternatively from 2 to 5 hours in a temperature range of from 90° C. to 240° C., alternatively from 90° C. to 180° C., alternatively from 100° C. to 165° C. In some embodiments, the styrenic polymer composition is a HIPS and the CIA may be introduced to the polymerization process concomitant with the dissolution of the elastomer. In such embodiments, the CIA may be in contact with the components of the reaction mixture for greater than 5 hours, alternatively for greater than 10 hours, alternatively for greater than 13 hours, alternatively for from 13 hours to 14 hours in a temperature range of from 25° C. to 240° C., alternatively from 50° C. to 240° C., alternatively from 110° C. to 240° C. In an alternative embodiment, the CIA may be incorporated into the reaction mixture that is to be fed to the polymerization reactor (i.e. the feed). In such embodiments the CIA may be present in the feed at ambient temperature for greater than 48 hours prior to use. The feed mixture may then be introduced to a polymerization reactor and the CIA may be subjected to the reaction process for from 5 to 6 hours in a temperature range of from 90° C. to 160° C. In other embodiments, the CIA may be introduced to the polymerization reactor at some point downstream of the first polymerization reactor. In such embodiments, the CIA may be subjected to the reaction process from 1 to 2 hours in a temperature range of from 160° C. to 270° C. In an alternative embodiment, the CIA may be introduced to the polymerization process at some time subsequent to the dissolution of the elastomer. In such embodiments, the CIA may be in contact with the components of the reaction mixture for from 0.5 hours to 2.0 hours in a temperature range of from 130° C. to 240° C. Additional details regarding solution or mass polymerization processes and residence times have been previously described herein.

In an embodiment, a mold release agent such as for example ZnSt may be present in the reaction mixture in the range of from 100 ppm to 5000 ppm, alternatively from 500 ppm to 5000 ppm, alternatively from 500 ppm to 2000 ppm. Antioxidants such as for example IRGANOX 1076 may be present in amounts of from 200 ppm to 2000 pp, alternatively from 750 ppm to 1500 ppm, alternatively from 750 ppm to 850 ppm, alternatively from 775 ppm to 825 ppm. In some embodiments, the antioxidant is introduced indirectly to the reaction mixture as a component in the elastomer formulation. For example IRGANOX 1520 may be present in an elastomer formulation in an amount of from 300 ppm to 3000 ppm, alternatively from 500 ppm to 1500 ppm by weight of the elastomer, alternatively from 1000 ppm to 1500 ppm, alternatively from 1100 ppm to 1300 ppm, alternatively 1200 ppm by weight of the elastomer. In such embodiments, the final antioxidant concentration in the HIPS originating from the elastomer may be in the range of from 80 ppm to 500 ppm, alternatively from 80 ppm to 400 ppm, alternatively from 80 ppm to 200 ppm.

In embodiments wherein the antioxidant is present as part of the elastomer formulation, the amount of antioxidant present during the HIPS polymerization process may increase during the course of the reaction as a result of the accumulation of the antioxidant in other portions of the polymerization reactor. For example, in a polymerization process, the percent conversion of styrene to polystyrene in the final reactor may vary from 65% to 75% leaving a significant amount of unreacted styrene and diluent such as ethylbenzene. The unreacted materials may be returned upstream using a process known as devolatilization wherein the unreacted styrene monomer is carried out of the reaction vessel at high reaction temperatures and pressures in a recycle stream. The reaction temperatures and pressures necessary for devolatilization will depend to some extent on the nature of the reactor and reaction conditions used and may be determined by one of ordinary skill in the art. Without wishing to be limited by theory, it is in the devolatilizer where secondary reactions leading to CFCs may occur due to the presence of impurities carried back to the reaction process by the recycle stream. For example, in an embodiment wherein the antioxidant is present in the elastomer, while the final concentration in the HIPS reaction mixture may be in the ranges set forth previously, the antioxidant may accumulate to a concentration of from 50 ppm to 200 ppm, alternatively 50 ppm to 150 ppm, alternatively 80 ppm to 100 ppm, in the recycle stream and contribute to the production of CECs.

In an embodiment, the polymerization reaction is carried out in a reactor system comprising a plurality of reactors. In one embodiment, both a metallic stearate (e.g., ZnSt) and a CIA (e.g. CSL) are introduced to the reactor system in which a polymerization reaction is occurring, such as the polymerization of styrene to form a HIPS or GPPS. In such an embodiment, the CIA may be introduced to the reaction mixture at a reactor upstream of and prior to contacting the metallic stearate. In an embodiment, the CIA may also be present in a reactor receiving a recycle stream comprising an elevated level of antioxidants, such as described previously herein. In such embodiments, the CIA may function to inhibit CFC formation and may be present prior to the addition of any additional metallic stearates.

In some embodiments, CSL is present in the reaction mixture prior to the addition of all the components required for production of a CFC. For example and without limitation, CSL (or other CIA) may be included in a reaction mixture or component comprising an antioxidant prior to the inclusion of an oxidizing agent such as a metallic stearate. In such embodiments, CSL may interact with the antioxidant and inhibit its oxidation by the metallic stearate thereby preventing the production of CFCs.

In an embodiment, the use of a CIA such as CSL may reduce color formation in HIPS comprising of one or more oxidizing agents such as peroxides, hydroperoxides or peroxide mixtures, metallic stearates or combinations thereof. Alternatively the use of a CIA such as CSL may reduce color formation in HIPS comprising one or more oxidizing agents such as those described previously herein.

In an embodiment, a styrenic polymer composition containing CSL has a reduced Yellowness index as determined in accordance with ASTM E 313 when compared to an otherwise identical composition lacking CSL. In an embodiment, a styrenic polymer composition has a 50% to 400% reduction, alternatively a 50% to 200% reduction, alternatively a 50% to 100% reduction in Yellowness index as determined in accordance with ASTM E 313 when compared to an otherwise identical polystyrene lacking a color improving additive. The styrenic polymer composition may be further characterized by a 50% to 200% reduction, alternatively a 50% to 150% reduction, alternatively a 50% to 100% reduction in b value as measured using a Hunter colorimeter when compared to an otherwise identical polystyrene lacking a color improving additive.

### EXAMPLES

The embodiments having been generally described, the following examples are given as particular embodiments of the disclosure and to demonstrate the practice and advantages thereof. It is understood that the examples are given by way of illustration and are not intended to limit the specification of the claims in any manner.

### Example 1

Feed solutions containing 5% of either DIENE-55 (D55) or KBR 710S elastomer, 175 PPM of LUPEROX 233, the indicated amount of zinc stearate containing low ash (13.4%) and the indicated amount of CSL were polymerized to form HIPS. DIEN-55 (D-55) is a low cis polybutadiene elastomer further comprising IRGANOX 1076 and TNPP, which is commercially available from Firestone. KBR 710S is a butadiene elastomer further comprising IRGANOX 1520, which is commercially available from Kumho. LUPEROX 233 (L233) is ethyl 3,3-d(t-butylperoxy)butyrate commercially available from ARKEMA, which serves as an organic peroxide initiator. CSL may also be referred to herein as PATIONIC 930 which is commercially available from American Ingredients Co.

Table 1 summarizes the results of the experiment carried out in a continuous pilot plant producing 40 kg/hr of HIPS employing two CSTRs and four PFRs in series. The pilot plant is equipped with a 2 stage devolatilizer and a condenser to % return the recycle to the second CSTR. Approximately, 8-10 kgs/hr of vapors are condensed and returned or recycled to the second CSTR. The pilot unit is a full-scale representation of a commercial line. The HIPS that was produced contained 8.5% elastomer and 3% mineral oil. D-55 contains 0.5-0.7% TNPP and 0.2-0.4% IRGANOX 1076. KBR 710S contains 1320 PPM of IRGANOX 1520. In addition to the additives that the elastomers contain, the following compounds are used: L-233 (175 ppm), and IRGANOX 1076 (1000 ppm). The levels of ZnSt and CSL are indicated in Table 1. The color of the resulting HIPS composition was measured using a Hunter colorimeter. The Hunter calorimeter uses an opponent-color scale that proved measurements of color in units of approximate visual uniformity. Thus in the Hunter scale, L measures lightness and varies from 100 for perfect white to zero for black, approximately as the eye would evaluate it. The chromacity dimensions (a and b) give understandable designations of color as follows:

a measures redness when positive, gray when zero and greenness when negative

b measures yellowness when positive, gray when zero, and blueness when negative

Additionally the Hunter colorimeter measures the yellowness index or YI. Visually, yellowness is associated with scorching, soiling and general product degradation by light, chemical exposure, and processing. Yellowness indices are used chiefly to measure these types of degradation. The yellowness index is calculated by the Hunter calorimeter per ASTM Method E 313. The results of the color measurements are presented in Table 1.

TABLE 1

| Run | | ZnST | CSL | | | | |
|---|---|---|---|---|---|---|---|
| Number | Elastomer | (ppm) | (ppm) | YI | b | a | L |
| 1 | D-55 | no | 0 | 0.31 | 0.58 | −1.07 | 86.1 |
| 2 | D-55 | 1000 | 0 | 1.96 | 1.47 | −1.31 | 85.8 |
| 3 | Kumho | 1000 | 0 | 3.33 | 2.23 | −1.56 | 85.8 |
| 4 | Kumho | 1000 | 1000 | −0.35 | 0.30 | −1.16 | 87.0 |

The results demonstrate that with the addition of CSL, Run 4, there is a significant reduction in color formation as evinced by the negative YI values and low b values.

### Example 2

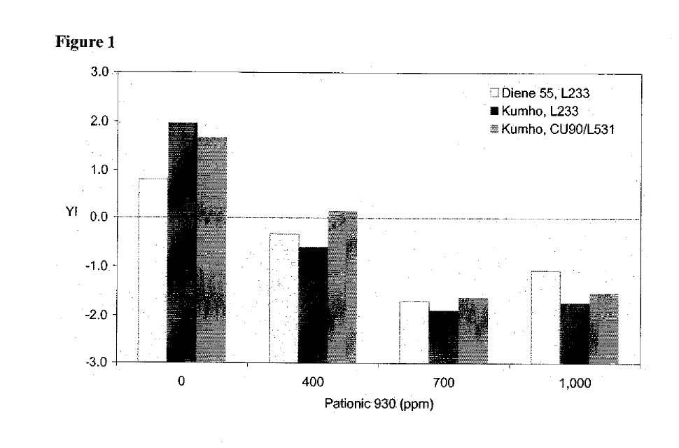

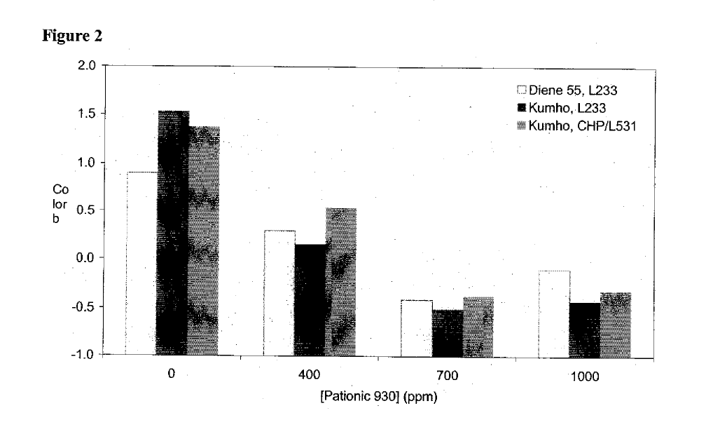

The effect of changing the peroxide initiator package and elastomer on the color of the HIPS resin produced was investigated. All resins were prepared under standard conditions for production of TOTAL 945E POLYSTYRENE. Resins were prepared using 1000 ppm Zinc Stearate (ZnSt), KBR 710S and a two initiator package and compared to resins prepared using the D-55 elastomer and a one initiator package. The two initiator package comprises CU90 which is cumin hydroperoxide and LUPEROX 531 MS0 (L531) which is 1,1-Di(t-amylperoxy)cyclohexane both of which are commercially available from ARKEMA. The numerical results of these experiments are given in Table 2. These results are graphically represented in FIGS. 1 and 2.

TABLE 2

| | | | | Reduction | | |
|---|---|---|---|---|---|---|
| | | | | in | Yellow | |
| Elastomer | Initiator | CSL | Color | Color b | Index | Reduction |
| Type | Package | (ppm) | b | (%) | (YI) | YI (%) |
| Firestone | L233 | 0 | 0.90 | n/a | 0.80 | n/a |
| D55 AC10 | | 400 | 0.29 | −68 | −0.34 | −143 |
| (Diene 55) | | 700 | −0.41 | −146 | −1.70 | −313 |
| | | 1000 | −0.10 | −111 | −1.07 | −234 |
| Kumho | L233 | 0 | 1.53 | n/a | 1.97 | n/a |
| KBR 710S | | 400 | 0.15 | −90 | −0.60 | −130 |
| | | 700 | −0.50 | −133 | −1.88 | −195 |
| | | 1000 | −0.42 | −127 | −1.72 | −187 |
| | K90/L531 | 0 | 1.38 | n/a | 1.68 | n/a |
| | | 400 | 0.54 | −61 | 0.14 | −92 |
| | | 700 | −0.37 | −127 | −1.61 | −196 |
| | | 1000 | −0.35 | −125 | −1.60 | −195 |

Note:
Color b and YI Reductions percents reported relative to baseline (no CSL) prepared for each initiator and/or rubber package by the following formula: Reduction: = 100 × (Color with CSL − Baseline color without CSL)/Baseline color without CSL

The results demonstrate a reduction in the yellow index values and reduced b values for HIPS comprising CSL regardless of the elastomer or initiator package used. The initiators used in this experiment had a range of one-hour half-life temperatures (t_{1/2}) with the L233 initiator having a t_{1/2}=130° C., the L531 initiator having a t_{1/2}=117° C. and the CU90 initiator having a t_{1/2}=170° C. The longer t_{1/2} of the CU90 initiator indicates that it would be present in the reaction mixture for a longer time period than either the L233 or L531 and thus may produce HIPS with increased color when compared to those produce with initiators that decompose more rapidly at lower temperatures. The results also demonstrate that CSL is effective in reducing color formation even in the presence of initiators having a higher degree of stability at elevated temperatures. Furthermore, Table 5 shows an optimum value of CSL is reached at 700 ppm which corresponds to a roughly 0.5 molar ratio of CSL to ZnSt.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of improving the color of a high impact polystyrene comprising:
preparing a reaction mixture comprising styrene, elastomer and at least one antioxidant; and
introducing to the reaction mixture a color improving additive prior to the addition of any oxidizing agents to the reaction mixture.

2. The method of claim 1 wherein a color improving additive is an alkali salt of an organic acid, an alkali salt of lactic acid, sodium stearoyl lactate, calcium stearoyl lactate or combinations thereof.

3. The method of claim 2 wherein the color improving additive is present in an amount of from 100 ppm to 5000 ppm.

4. The method of claim 1 wherein the color improving additive is calcium stearoyl lactate.

5. The method of claim 4 wherein the calcium stearoyl lactate is present in an amount of from 100 ppm to 5000 ppm.

6. The method of claim 1 wherein the styrene is a substituted styrene, a ring-substituted styrene, a disubstituted styrene, an unsubstituted styrene or combinations thereof.

7. The method of claim 1 wherein the elastomer is a polymer of an aliphatic conjugated diene.

8. The method of claim 7 wherein the aliphatic conjugated diene is a butadiene monomer.

9. The method of claim 1 wherein the oxidizing agent is a metallic stearate, an initiator, air or combinations thereof.

10. The method of claim 1 wherein the oxidizing agent is present in an amount of from 50 ppm to 2500 ppm.

11. The method of claim 1 wherein the antioxidant comprises a phenol, a catechol, ris-nonylphenylphosphite (TNPP), 2,6 ditertiarybutyl-4-methyl phenol, Octadecyl 3,5-Di-(tert)-butyl-4-hydroxyhydrocinnamate, 4-bis[(octylthio)methyl]-o-cresol, or combinations thereof.

12. The method of claim 1 wherein the antioxidant is present in an amount of from 100 ppm to 10,000 ppm.

13. The method of claim 1 wherein the polystyrene has a 50% to 200% reduction Yellowness index as determined in accordance with ASTM E 313 when compared to an otherwise substantially similar polystyrene lacking a color improving additive.

14. The method of claim 1 wherein the polystyrene has a 50% to 400% reduction in b value as measured using a Hunter colorimeter when compared to an otherwise identical polystyrene lacking a color improving additive.

15. The method of claim 1 wherein the reaction mixture has a residence time of 0.5 to 14 hours within one or more reactors.

16. The method of claim 1 wherein the polystyrene is prepared via a mass polymerization process.

17. The method of claim 1 wherein the polystyrene is prepared via a solution polymerization process.

18. The method of claim 14 wherein the one or more reactors are operated in a temperature range of from 110° C. to 240° C.

19. The method of claim 1 wherein the styrene, elastomer and at least one antioxidant are combined in a first reactor vessel and the oxidizing agent is added in a second reactor vessel located downstream from the first reactor vessel.

20. The method of claim 18 wherein the first reactor vessel is a continuously stirred tank reactor and the second reactor vessel is a plug flow reactor.

21. A high impact polystyrene comprising a color improving additive, an elastomer and at least one antioxidant wherein the color improving additive is present in the reaction process for production of the high impact polystyrene prior to the introduction of an oxidizing agent and wherein the high impact polystyrene has a 50% to 200% reduction in the Yellowness index as determined in accordance with ASTM E 313 when compared to an otherwise identical polystyrene lacking a color improving additive.
